(19) United States
(12) Patent Application Publication
(10) Pub. No.: US 2006/0027313 A1
(43) Pub. Date: Feb. 9, 2006

(54) Method for making grip on handle

(76) Inventor: Leo Jaw, Taichung County (TW)

Correspondence Address: BACON & THOMAS, PLLC, 625 SLATERS LANE, FOURTH FLOOR, ALEXANDRIA, VA, 22314, US

(21) Appl. No.: 10/913,412

(22) Filed: Aug. 9, 2004

(51) Int. Cl. B29D 22/00

(52) U.S. Cl. 156/213

(57) ABSTRACT

A method for making a grip on a handle of a sports apparatus includes the steps of forming a synthetic leather having a base supporting member and a polyurethane layer bonded to the base supporting member, then cutting the synthetic leather into a synthetic leather sheet member having two longitudinal lateral sides, then attaching a double-sided adhesive tape to the base supporting member, and covering and adhering the synthetic leather sheet member on the handle of the sports apparatus to form a grip on the handle of the sports apparatus by connecting the longitudinal lateral sides of the synthetic leather sheet member.

### BACKGROUND OF THE INVENTION

1. Field of the Invention

The present invention relates generally to a method for making a grip on the handle of a sports apparatus and more particularly, to a method for making a grip on a handle by using a synthetic leather sheet member that covers the handle and has two lateral sides connected together.

2. Description of the Related Art

As shown in FIGS. 1 and 2, an elongated grip belt 2 is spirally wound around a golf club handle 1 to form a grip on the golf club handle 1 for holding by a user. During installation, one end of the grip belt 2 is pressed on one end of the golf club handle 1, and then the grip belt 2 is wound round the golf club handle 1 spirally. During winding, the worker must be careful about the applied force and the overlapping status of the side edges of the grip belt 2. If the grip belt 2 is not properly stretched during installation, the grip belt 2 will show a loosen status after installation. Further, if the overlapped area is too big, a protrusion will form in the installed grip belt, giving an uncomfortable touch to the user's hand; if the overlapped area is insufficient, sweat or dirt may pass into gaps in between the inner side of the grip belt 2 and the periphery of the golf club handle 1. Therefore, winding the grip belt 2 on the golf club handle 1 needs a special technique.

### SUMMARY OF THE INVENTION

It is the primary objective of the present invention to provide a method for making a grip on a handle, which is easy to make a grip on the handle of a sports apparatus.

To achieve this objective of the present invention, the method provided by the present invention comprises the steps of providing a synthetic leather sheet member having two longitudinal lateral sides, and then covering the synthetic leather sheet member on a handle of a sports apparatus and connecting the two longitudinal lateral sides of the synthetic leather sheet member to form a grip that covers the handle of the sports apparatus.

In a preferred embodiment of the present invention, the synthetic leather sheet member is prepared by the steps of a) providing a releasable temporary supporting member, then b) coating one side of the releasable temporary supporting member with liquefied polyurethane, then c) curing the liquefied polyurethane to form a polyurethane layer having pores therein on the releasable temporary supporting member, then d) separating the releasable temporary supporting member from the polyurethane layer, then e) bonding a base supporting member to one side of the polyurethane layer to form a synthetic leather, and then f) cutting the synthetic leather into the synthetic leather sheet members subject to a predetermined size.

### BRIEF DESCRIPTION OF THE DRAWINGS

FIG. 1 is a schematic drawing showing an application of a grip belt according to the prior art.

FIG. 2 illustrates a grip belt bonded to the handle of a golf club according to the prior art.

FIG. 3 is a schematic drawing showing the formation of the polyurethane layer on the releasable temporary supporting member according to the present invention.

FIG. 4 is a sectional view taken in an enlarged scale along line 4-4 of FIG. 3.

FIG. 5 is a sectional view taken in an enlarged scale along line 5-5 of FIG. 3.

FIG. 6 is an enlarged view of a part of FIG. 5.

FIG. 7 is a schematic drawing showing that the base supporting member is bonded to the polyurethane layer after the releasable temporary supporting member is separated from the polyurethane layer according to the present invention.

FIG. 8 is a sectional view taken in an enlarged scale along line 8-8 of FIG. 7.

FIG. 9 is a schematic drawing showing that the synthetic leather is cut into a synthetic leather sheet member subject to a desired size.

FIG. 10 is a sectional view taken in an enlarged scale along line 10-10 of FIG. 9.

FIG. 11 is a schematic drawing showing installation of the synthetic leather sheet member on the handle of a golf club handle according to the present invention.

FIG. 12 is similar to FIG. 11, showing that a grip is formed on the handle of the golf club after the longitudinal sides are connected together.

FIG. 13 is a cross-sectional view taken along line 13-13 of FIG. 12.

FIG. 14 is a cross-sectional view showing the synthetic leather sheet member is covered around a sleeve that is sleeved onto a core member of the handle.

FIG. 15 is a sectional view showing two beveled cutting edges formed in the two opposite longitudinal lateral sides of the synthetic leather sheet member in parallel according to the present invention.

FIG. 16 is a cross-sectional view showing that the synthetic leather sheet member shown in FIG. 15 is covered on the handle of a gold club.

FIG. 17 is a sectional view showing two beveled cutting edges formed in the two opposite longitudinal lateral sides of the synthetic leather sheet member in different directions according to the present invention.

FIG. 18 is a cross-sectional view showing that the synthetic leather sheet member shown in FIG. 17 is covered on the handle of a gold club.

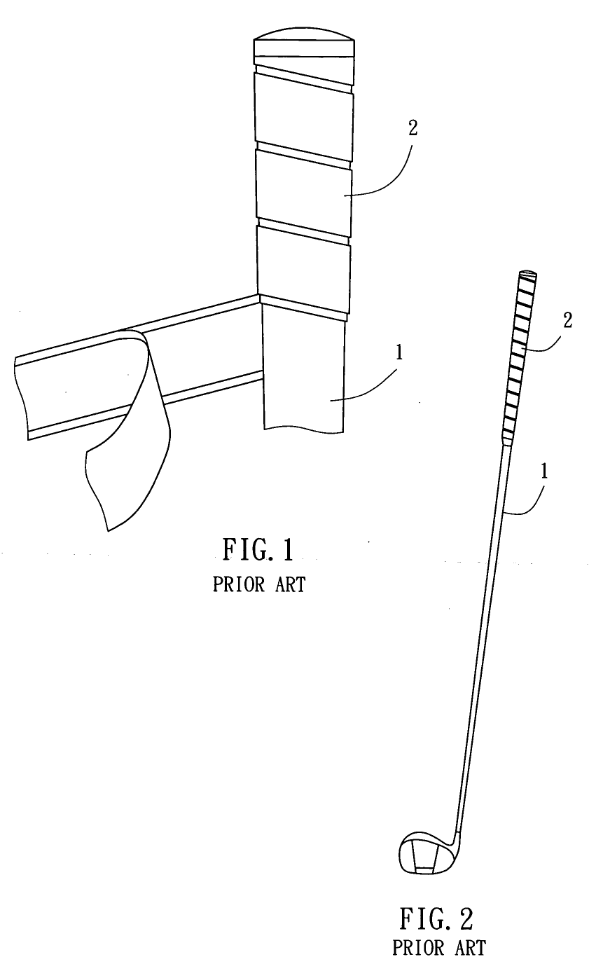

### DETAILED DESCRIPTION OF THE INVENTION

The method provided by the present invention is basically comprised of the steps of forming a synthetic leather, then cutting the synthetic leather into a synthetic leather sheet member having two longitudinal lateral sides, and then covering the synthetic leather sheet member on a handle of a sports apparatus to form a grip on the handle of the sports apparatus by connecting the two longitudinal lateral sides of the synthetic leather sheet member.

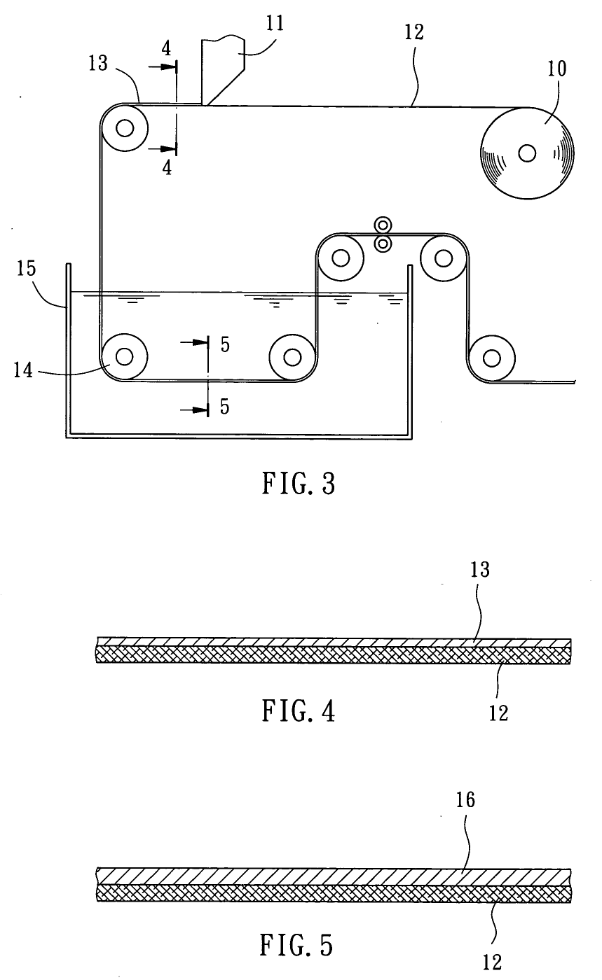

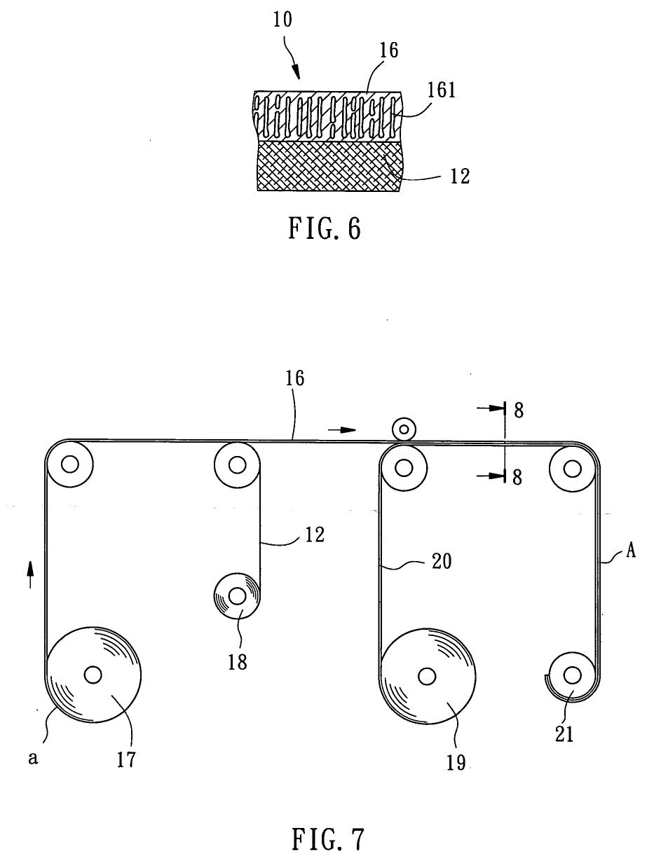

The synthetic leather forming process includes a first step of forming a single polyurethane layer 16 on a releasable temporary supporting member 12, as shown in FIG. 3, and a second step of bonding a base supporting layer 20 to the polyurethane layer 16 after the temporary supporting member 12 is separated from the polyurethane layer 16, as shown in FIG. 7.

As shown in FIG. 3, the releasable temporary supporting member 12 is delivered forwards from a supply reel 10 toward a dispensing nozzle 11. The supporting member 12 can be nylon cloth, fluid penetrative textile, polyester cloth, and etc. According to the present preferred embodiment, nylon cloth is used for the supporting member 12. The dispensing nozzle 11 is controlled to apply liquefied PU (polyurethane) 13 to one side of the supporting member 12 (see FIG. 4).

The liquefied PU 13 coated supporting member 12 is guided by a set of guiding rollers 14 to pass through a solution in a water trough 15. This procedure is well known as the wet process for foaming polyurethane, which causes the liquefied PU 13 to make a reaction and to form into a cured PU layer 16 on the supporting member 12. The cured PU layer 16 has a plurality of pores 161 inside, as shown in FIG. 6. The PU layer 16 and the supporting member 12 form a semi-finished synthetic leather a, which is rolled up on a reel.

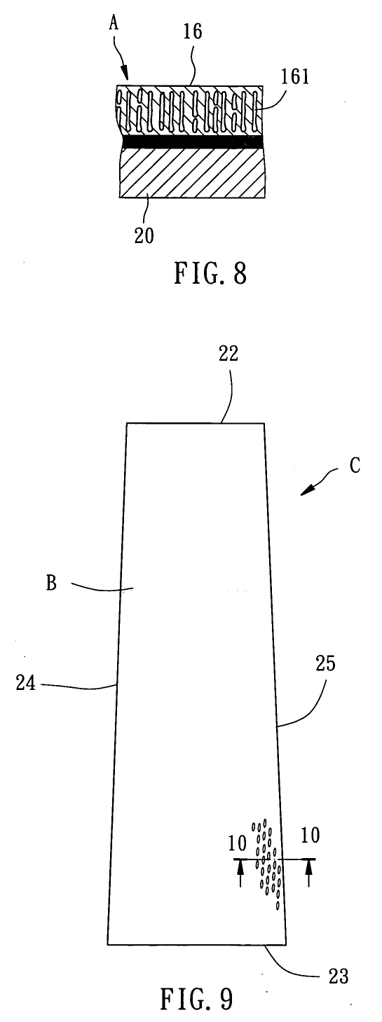

As shown in FIG. 7, the semi-finished synthetic leather a is pulled out of the reel 17 and delivered forwards in the arrow sign-indicated direction. During forward delivery, the temporary supporting member 12 is separated from the PU layer 16 and rolled up by a roll 18, and the PU layer 16 is continuously delivered forward and adhered to one side of a base supporting member 20 supplied from a supply roll 19 (the darkened part shown in FIG. 8 indicates the bonding layer (glue)), thereby forming a shock-absorbing synthetic leather A, which is rolled up by a reel 21. The base supporting member 20 reinforces the structural strength of the PU layer 16, and can be obtained from synthetic resin, natural leather, textile, or non-woven fabric. Preferably, the base supporting member 20 is made of EVA (ethylene vinyl acetate) for absorbing shock.

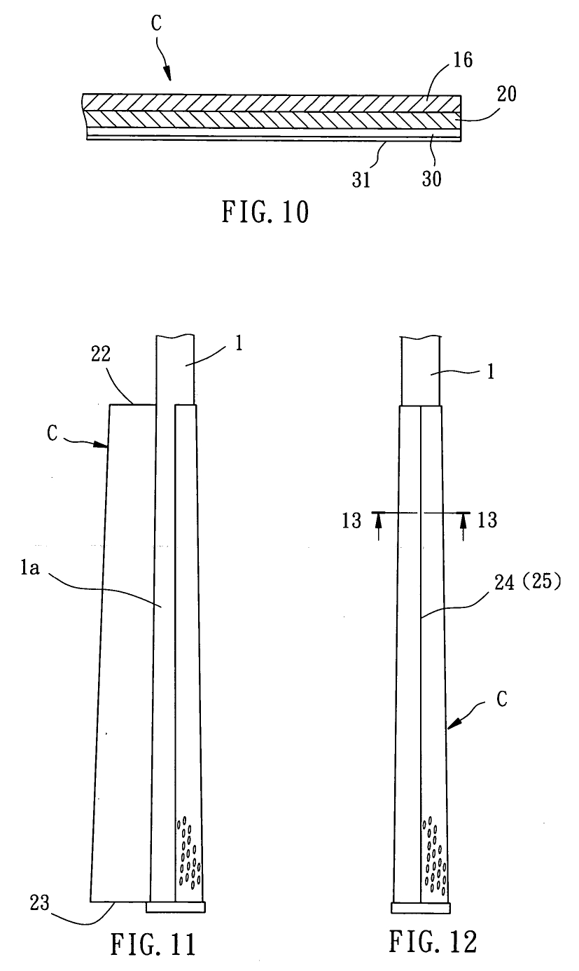

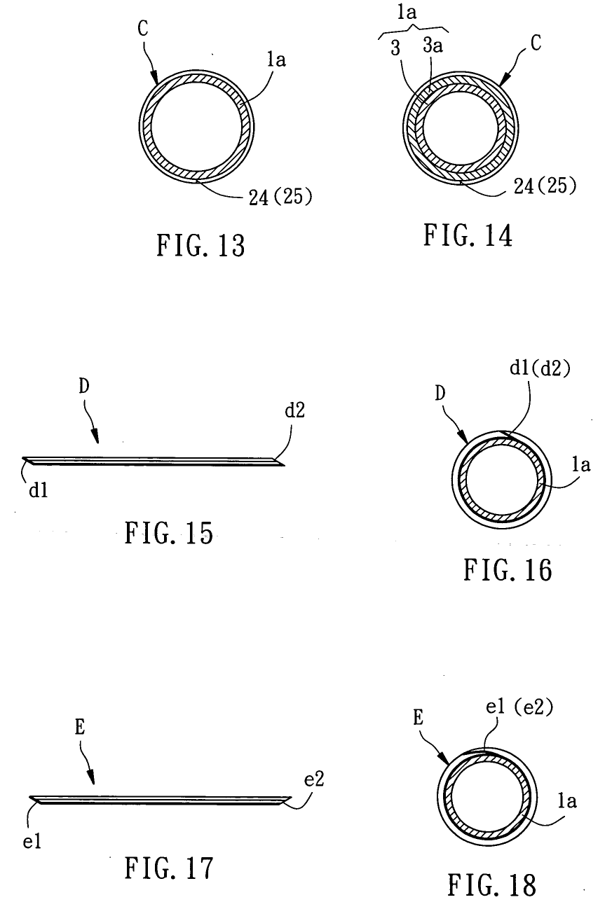

After the shock-absorbing synthetic leather A is made, the shock-absorbing synthetic leather A is properly cut into trapezoidal members B subject to a predetermined size, as shown in FIG. 9, for covering the periphery of the handle of a sports apparatus, for example, golf club. Each trapezoidal member B has a first transverse side 22, a second transverse side 23, and two longitudinal lateral sides 24 and 25. According to the present preferred embodiment, the length ration between the first transverse side 22 and the second transverse side 23 is 3:4. At final, the bottom side of each trapezoidal member B (i.e., the exposed side of the base supporting member 20) is covered with a double-sided adhesive tape 30, as shown in FIG. 10, thereby forming the finished synthetic leather sheet member C. The double-sided adhesive tape 30 has one side directly adhered to the trapezoidal member B and the other side covered with a strippable backing 31 for protection.

When using the synthetic leather sheet member C, remove the strippable backing 31 from the double-sided adhesive tape 30, and then cover and adhere the synthetic leather sheet member C on the periphery of, for example, the handle 1a of a golf club 1. By means of the size design of the first transverse side 22 and the second transverse side 23, the synthetic leather sheet member C tightly covers the whole area of the periphery of the handle 1a of a golf club 1. After covering, the two longitudinal lateral sides 24 and 25 are abutted against each other, and then sealed together by a high-frequency heat-sealing process.

To a handle 1a having a core member 3 and a rubber sleeve 3a that is sleeved onto the core member 3, the synthetic leather sheet member C can directly be covered on the rubber sleeve 3 of the handle 1a, as shown in FIG. 14.

Further, after cutting shock-absorbing synthetic leather A into trapezoidal members B, the longitudinal lateral sides 24 and 25 of each trapezoidal members B may be beveled. For example, the synthetic leather sheet member D shown in FIG. 15 has two beveled cutting edges d1 and d2 formed in the two opposite longitudinal lateral sides and arranged in parallel such that the beveled cutting edges d1 and d2 of the synthetic leather sheet member can be complementarily overlappedly connected together. FIG. 16 is a cross sectional view showing the synthetic leather sheet member D fastened to a handle 1a. Alternatively, the synthetic leather sheet member E shown in FIG. 17 has two beveled cutting edges e1 and e2 formed in the two opposite longitudinal lateral sides and respectively sloping upwardly outwards from the base supporting member toward the polyurethane layer. FIG. 18 is a cross sectional view showing the synthetic leather sheet member E fastened to a handle 1a.

What is claimed is:

1. A method for making a grip on a handle of a sports apparatus, said method comprising the steps of:
a) providing a releasable temporary supporting member;
b) coating one side of said releasable temporary supporting member with liquefied polyurethane;
c) curing said liquefied polyurethane to form a polyurethane layer having pores therein on said releasable temporary supporting member;
d) separating said releasable temporary supporting member from said polyurethane layer;
e) bonding a base supporting member to one side of said polyurethane layer, thereby forming a synthetic leather;
f) cutting said synthetic leather into synthetic leather sheet members subject to a predetermined size, said synthetic leather sheet members each having two longitudinal lateral sides; and
g) covering said synthetic leather sheet member on a handle of a sports apparatus and connecting the two longitudinal sides of the synthetic leather sheet member to form a grip that covers the handle of the sports apparatus.

2. The method as defined in claim 1, wherein said synthetic leather sheet member has a first transverse side and a second transverse side longer than the first transverse side.

3. The method as defined in claim 2, wherein a length ratio between said first transverse side and said second transverse side is 3:4.

4. The method as defined in claim 1, further comprising the step of cutting the two longitudinal lateral sides of said synthetic leather sheet member to form a respective beveled cutting edge after the step f).

5. The method as defined in claim 4, wherein the two beveled cutting edges at the two longitudinal lateral sides of said synthetic leather sheet member are arranged in parallel such that the beveled cutting edges of the synthetic leather sheet member are complementarily overlappedly connected together in the step g).

6. The method as claimed in claim 4, wherein the two beveled cutting edges at the two longitudinal lateral sides of said synthetic leather sheet member respectively slope upwardly outwards from the base supporting member toward the polyurethane layer.

7. The method as defined in claim 1, further comprising a step of attaching a double-sided adhesive tape to the base supporting member of the synthetic leather sheet member before the step g).

8. A method for making a grip on a handle, comprising the steps of:
a) providing a synthetic leather sheet member having two longitudinal lateral sides; and
b) covering the synthetic leather sheet member on a handle of a sports apparatus and connecting the two longitudinal lateral sides of the synthetic leather sheet member to form a grip that covers the handle of the sports apparatus.

9. The method as defined in claim 8, wherein the synthetic leather sheet member comprises a base supporting layer and a polyurethane layer that has a plurality of pores inside and is bonded to the base supporting layer.

10. The method as defined in claim 9, wherein the base supporting layer is made from ethylene vinyl acetate, natural leather, polyurethane or non-woven fabric.

11. The method as defined in claim 8, wherein the longitudinal lateral sides of the synthetic leather sheet member each have a beveled cutting edge; wherein the beveled cutting edges of the synthetic leather sheet member are overlappedly connected together.

12. The method as defined in claim 11, wherein the beveled cutting edges of the synthetic leather sheet member are complementary in shape and connected together.

13. The method as defined in claim 8, wherein the handle of the sports apparatus comprises a core member and a sleeve that is sleeved onto the core member; wherein the synthetic leather sheet member is covered on the sleeve of the handle.
